(19) United States
(12) Patent Application Publication
(10) Pub. No.: US 2025/0390176 A1
(43) Pub. Date: Dec. 25, 2025

(54) SYSTEM AND METHOD FOR FACILITATING HAND SIGNAL RECOGNITION AND COMMUNICATION IN CONSTRUCTION OPERATIONS

(71) Applicant: Ghulam Muhammad Ali, Edmonton (CA)

(72) Inventor: Ghulam Muhammad Ali, Edmonton (CA)

(21) Appl. No.: 19/176,163

(22) Filed: Apr. 11, 2025

Related U.S. Application Data
(60) Provisional application No. 63/633,372, filed on Apr. 12, 2024.

(51) Int. Cl. G06F 3/01; G06T 7/70

(52) U.S. Cl. CPC G06F 3/017; G06T 7/70; G06T 2207/30196

(57) ABSTRACT

A system and method are disclosed for enabling reliable hand signal recognition and communication between a signalman and a construction equipment operator. The system includes a glove module with embedded sensors for detecting hand gestures, a helmet module with cameras for capturing visual images of gestures, a receiver module for synchronizing and validating gesture and image data to generate a single decisive hand signal, and a display module located in the equipment cabin. The display module presents the validated hand signal visually and audibly to the operator and transmits a confirmation signal back to the receiver module. The system supports real-time, bidirectional communication through wireless and wired links and incorporates periodic verification to maintain communication integrity. The method includes steps for data acquisition, synchronization, validation, communication, and confirmation of hand signals to ensure safe and efficient operations in visually constrained construction environments.

Priority Claim: This application claims the benefit of U.S. Provisional Application No. 63/633,372, filed on Apr. 12, 2024, the entire contents of which are incorporated herein by reference.

### FIELD

The present invention relates generally to communication systems for enhancing safety in construction equipment operations. More specifically, it pertains to systems and methods for facilitating hand signal recognition using visual and auditory mechanisms to enable clear and effective communication between signalmen and equipment operators.

### BACKGROUND

The construction industry primarily depends on machinery to execute a wide range of operations. Ensuring the safety of signalmen and construction equipment operators is of utmost importance during such operations, as even minor oversights can lead to severe accidents. Inadequate communication between signalmen and operators significantly contributes to these incidents. To address this concern, standardized universal hand signals have been established to reduce the risk of accidents. These signals are communicated by signalmen to equipment operators, with signalmen serving as the operator's primary source of visual and auditory information. However, despite implementing these protocols, communication challenges frequently escalate to a critical level, thereby considerably heightening the risk of injuries or fatalities within the construction sites.

For instance, within construction equipment operations, communication challenges are notably intensified during blind lifts. A blind lift pertains to a circumstance where the mobile crane operator's line of sight to either the load being lifted or the signalman's hand signals is obstructed or significantly restricted due to physical barriers, structural enclosures, or the arrangement of the crane itself. In these instances, the operator cannot maintain direct visual contact with the load or the signalman, thereby augmenting the reliance on indirect communication methods.

Various approaches have been employed to address the communication challenges between the signalman and the equipment operator. One conventional method involves using a relay system comprising multiple signalmen, as illustrated in FIG. 6, wherein hand signals from the primary signalman are relayed to the equipment operator located within the cabin of the construction equipment. Another approach utilizes a two-way radio communication system to transmit verbal instructions directly to the operator.

However, these conventional methodologies exhibit inherent limitations that may result in communication delays and disruptions, consequently increasing the probability of accidents. The utilization of multiple signalmen within relay systems introduces complications such as communication latency attributable to signal transmission through intermediaries, heightened labor expenses, and the potential for misinterpretation or conflicting instructions. Likewise, two-way radio communication systems present a range of operational challenges. Language barriers constitute a significant concern, particularly in multicultural work environments where varied native languages among operators and signalmen can hinder effective verbal communication. Furthermore, such systems are susceptible to interference from the naturally noisy construction environment, where the presence of loud machinery and ongoing activities can impair audio clarity, resulting in overlooked or misinterpreted instructions. Additionally, reliance on radio communication may distract both the operator and the signalman, necessitating a division of focus between equipment operation and verbal interaction, thereby compromising situational awareness and overall safety.

Hence, the existing methods can compromise the efficiency and safety of the equipment's operation and potentially impact the efficiency of the equipment's operation, thereby increasing the risk of accidents.

In the known prior art, “A Deep-Learning Classification Framework for Reducing Communication Errors in Dynamic Hand Signaling for Crane Operation,” Journal of Construction Engineering and Management, 149 (2), 04022167, authored by Mansoor, A., Liu, S., Ali, G. M., Bouferguene, A., and Al-Hussein, M. (2023), a stationary camera is used to capture images of hand signals performed by a mobile crane signalman. These images are processed using computer vision and image recognition techniques, and the resulting data are utilized to train a machine learning model that continuously updates a hand signal dataset. However, this system lacks the use of wearable sensing devices and does not support real-time verification or bidirectional communication between the signalman and the operator.

In another known prior art, “Mobile Crane Signalman Static Hand Signals Classification Framework Using Deep Convolution Neural Network,” Proceedings of the 34th European Modeling & Simulation Symposium, Rome, Italy, Sep. 19-21, 2022, authored by Mansoor, A., Liu, S., Ali, G. M., Bouferguene, A., Al-Hussein, M., and Soda, a similar methodology is employed using a stationary camera and computer vision techniques to classify static hand signals. Deep convolutional neural networks are trained on captured images for recognition accuracy. However, this system does not incorporate wearable modules nor does it support signal confirmation via cross-sensing methods or provide direct operator feedback.

In “Conceptual Framework for Safety Improvement in Mobile Cranes,” Construction Research Congress 2020 (pp. 964-971), authored by Mansoor, A., Liu, S., Ali, G. M., Bouferguene, A., and Al-Hussein, M. (2020), a conceptual framework is proposed wherein a camera is mounted on a signalman's helmet to capture video footage. The video is segmented into frames and processed using mathematical algorithms to interpret the contents. These are then translated into visual commands for display in the operator's cabin. However, this framework lacks physical sensor-based gesture detection (e.g., from gloves), and does not perform real-time cross-verification of gestures or auditory confirmation.

In the prior art “Automated Recognition of Hand Gestures for Crane Rigging Using Data Gloves in Virtual Reality,” 39th International Symposium on Automation and Robotics in Construction (2022), authored by Harichandran, A., and Teizer, J., gloves equipped with flex sensors are used to detect hand gestures within a virtual reality training environment. The gestures are interpreted and used primarily for educational simulations. However, this system is limited to virtual environments and does not facilitate field-level deployment, real-time bidirectional communication, or integration with helmet-based visual sensing for verification.

In another known prior art, “Multimodal Hand Signal and Speech Communication Classification Framework for the Construction Industry: The Case of Communication Between Crane Signalman and Crane Operator,” authored by Mansoor, A. (2023), a hybrid methodology using both computer vision and glove flex sensors is disclosed. A stationary camera is used to capture hand signal images, which are analyzed via machine learning algorithms, and used to improve dataset quality. However, the system lacks portability and real-time cross-verification capabilities, and does not support integrated visual/audio feedback loops between the signalman and operator.

In international patent application WO2014210502A1, a non-contact sensing device comprising a plurality of function key sensors is disclosed. Each function key sensor has a defined field of view for detecting hand gestures and generating corresponding control signals. A processor interprets these signals and outputs control commands to a remote apparatus. However, this invention is limited to gesture-activated control without any wearable system, signal validation step, or operator feedback mechanism.

In the known prior art CN104317403B, a wearable system for sign language recognition is disclosed, comprising data gloves with strain gauges and inertial sensors, and a head-mounted device with infrared receivers and motion sensors. The system collects hand posture, position, and head movement data, transmitting it via Bluetooth for cloud-based processing. However, it is designed for sign language translation and does not address real-time, dual-sensor verification or operator feedback in construction equipment environments.

In the known prior art KR101216065B1, a system for remotely operating a resource development robot is disclosed, wherein a user wears marker gloves tracked by multiple cameras to recognize three-dimensional movement. The system calculates joint angles from the glove movement, transmits them wirelessly, and uses them to control robotic arms. While this system enables camera-based gesture recognition, it is designed for robotic control in mining and does not include wearable cross-verification (e.g., glove+helmet), nor does it provide real-time bidirectional communication or audio-visual feedback tailored for construction signalman-operator communication.

In the known prior art U.S. Pat. No. 10,572,024B1, a head-mounted display (HMD) is disclosed for tracking hand gestures using an ultrasound sensor, optionally combined with a camera. The system identifies hand poses, even when obstructed, through ultrasound signal reflection and machine learning models trained on timing and waveform features. However, this system is intended for augmented or virtual reality environments and does not involve wearable glove-based sensors, cross-verification between multiple devices, or visual/audio feedback mechanisms tailored for construction safety communication between a signalman and an operator.

In the known prior art WO2023171711A1, a wearable hand gesture recognition system is disclosed that uses flex sensors, inertial sensors, and machine learning to interpret hand signals. The system includes a glove configured to detect gestures and transmit data wirelessly to an external device for interpretation and action. While this system provides detailed gesture detection using sensor fusion and machine learning, it is not designed for real-time dual-verification between wearable devices, nor does it include graphical or audio feedback for communication between a signalman and a construction equipment operator.

Thus, it is desirable to provide a solution that addresses communication challenges in construction equipment operations.

### SUMMARY

A communication system is disclosed for the recognition and confirmation of hand signals. The system includes a first wearable device comprising one or more sensors embedded in gloves worn by a user, configured to detect specific hand gestures. A second wearable device includes two or more cameras mounted on the user's helmet to visually capture these gestures. A handheld processing device receives sensor data wirelessly from the gloves and visual data via a wired connection from the cameras. It compares both inputs to determine congruence and generates a single validated hand signal.

The system further includes a display module located within the cabin of construction equipment, which wirelessly receives and presents the validated hand signal both visually and audibly to the operator. A wireless communication network interconnects the wearable sensors, handheld device with wired cameras, and display module, supporting seamless bidirectional communication and ensuring synchronized announcements between devices.

A method for facilitating hand signal communication is also disclosed. The method comprises detecting hand gestures using glove-embedded sensors; capturing corresponding images of the hand gestures using helmet-mounted cameras; processing the sensor and visual inputs to determine a validated hand signal; transmitting the validated hand signal to a display module installed within construction equipment; presenting the validated hand signal both visually and audibly to the equipment operator; and transmitting a confirmation signal from the display module back to the handheld device, which audibly announces the same hand signal, thereby confirming successful receipt and presentation.

### BRIEF DESCRIPTION OF THE DRAWINGS

Various objects, features, and advantages of the present invention will become apparent from the following detailed description of exemplary embodiments, taken in conjunction with the accompanying drawings. The drawings are not necessarily to scale; instead, emphasis is placed on illustrating the principles and components of the invention. Like reference, numerals are used to indicate elements throughout the drawings.

FIG. 1 illustrates an example of the first wearable device (glove module) configured to detect hand gestures performed by a signalman and transmit corresponding data to a handheld processing device in accordance with an embodiment of the present disclosure;

FIG. 2 illustrates an example of a second wearable device (helmet module) comprising a helmet with mounted cameras in accordance with an embodiment of the present disclosure;

FIG. 3 illustrates an example of a handheld device (receiver module) configured to receive and transmit data between the first wearable device, the second wearable device, and a display module in accordance with an embodiment of the present disclosure;

FIG. 4 illustrates an example of a visual interface (display module) that graphically displays the hand signal and provides a vocal announcement in accordance with an embodiment of the present disclosure;

FIG. 5 illustrates the wired/wireless communication network between the first wearable (glove module), second wearable (helmet module), handheld device (receiver module) and the display module in accordance with an embodiment of the present disclosure;

FIG. 6 depicts a prior art relay communications arrangement of signalmen and an operator.

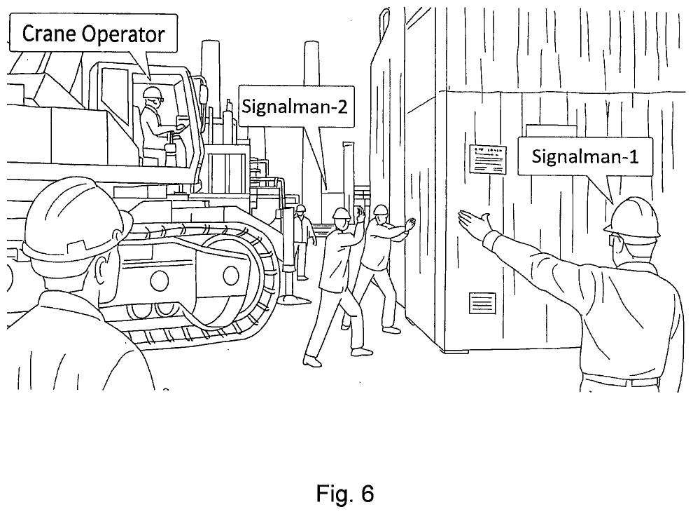

### DETAILED DESCRIPTION

Various embodiments of the present disclosure will now be described with reference to the accompanying figures. The figures are not necessarily drawn to scale and are provided for illustrative purposes only. Emphasis is placed on clearly conveying the functional relationships and contributions of the various components. Throughout the description, alternative implementations and features are described and may be interchanged or combined. It should be understood that such features may be interchanged or combined in different configurations, as would be apparent to a person skilled in the art, to produce other embodiments within the scope of the present disclosure.

The present disclosure describes a system and method for facilitating hand signal recognition to address communication challenges in construction equipment operations, particularly in scenarios where direct visual contact between the signalman and the operator is restricted. The system includes a first wearable device equipped with sensors configured to detect hand gestures, and a second wearable device that includes one or more cameras and a handheld processing unit. The receiver module processing unit is configured to receive sensor data from the first wearable device and image data from the cameras, and to process and compare these inputs to generate a validated hand signal. The validated hand signal is communicated to the operator via a display module providing both visual and auditory outputs. Auditory feedback may also be delivered to the signalman, thereby establishing real-time, bidirectional communication between the signalman and the operator.

### Communication System for Facilitating Hand Signal Recognition

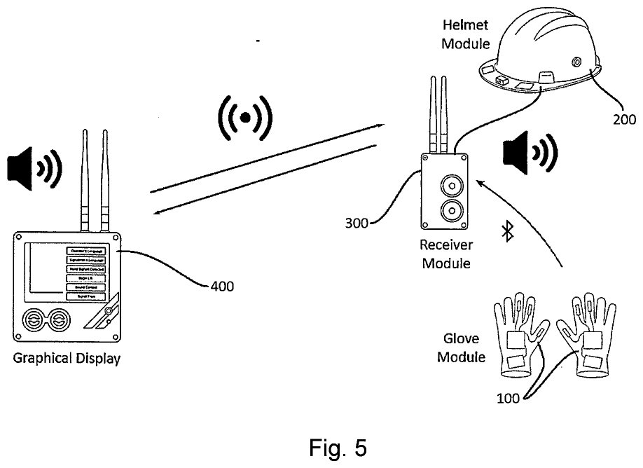

Referring to FIG. 5, a communication system for facilitating a hand signal recognition system is disclosed. The communication system comprises a first wearable device (100), a second wearable device (200), a handheld device (300), a visual interface (400), and a wireless communication network. The first wearable device (100) and the handheld device (300) are connected wirelessly via Bluetooth technology. The second wearable device (200) and the handheld device (300) are interconnected via a wired connection to support high-speed data transfer. The handheld device (300) and the display module (400) are connected via the wireless communication network to enabling real-time transmission of validated hand signal data to the operator.

The first wearable device (100) comprises one or more sensors configured to detect hand gestures performed by a signalman. The second wearable device (200) comprises one or more cameras configured to capture images or video frames of the signalman's hand gestures. The handheld device (300) includes a processing unit configured to receive gesture data from the first wearable device (100) and image data from the second wearable device (200) and to compare the two to confirm the sensed hand gesture corresponding to the visual gesture. Upon confirmation, the system generates a single decisive hand signal. The display module (400) graphically displays the decisive hand signal to an operator and transmits a confirmation response to the handheld device (300) via the wireless communication network, thereby ensuring reliable gesture communication between the signalman and the operator.

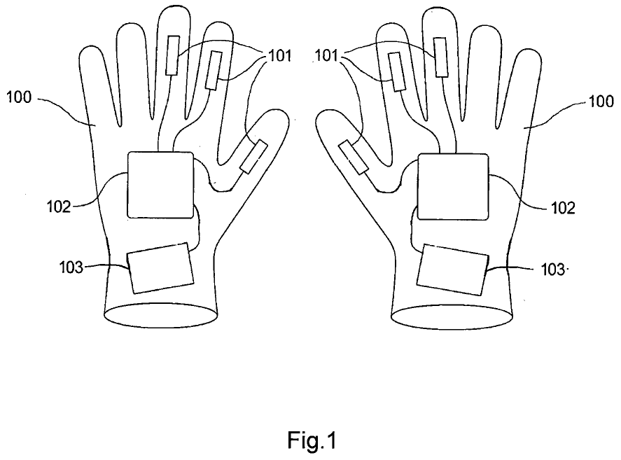

As illustrated in FIG. 1 and FIG. 5, the first wearable device (100), hereinafter referred to as the glove module, preferably includes a pair of glove modules (100), one for each hand. Each glove module (100) incorporates one or more sensors (101) configured to accurately measure the bending of the thumb, index finger, and middle finger. In a preferred embodiment, one or more sensors include at least three sensors per glove module (100). On the backside of the glove module (100), a battery storage unit (103) is located to provide power to the glove module. Each glove module (100) further comprises a glove module processing unit mounted on the back side of the glove. The glove module processing unit comprises motion-tracking devices (102), such as a 3-axis gyroscope and a 3-axis accelerometer, configured to precisely detect the rotation and movement of the glove module (100). The glove module processing unit also includes a power regulator for managing the power supply and a Bluetooth transmitter for wireless communication. The motion-tracking devices in the processor (102) are optimized for low power consumption, cost-effectiveness, and high performance. The glove module processing unit (102) is configured to process the sensed hand signals generated by a wearer or signalman and transmit gesture recognition data to the handheld device (300) via Bluetooth communication.

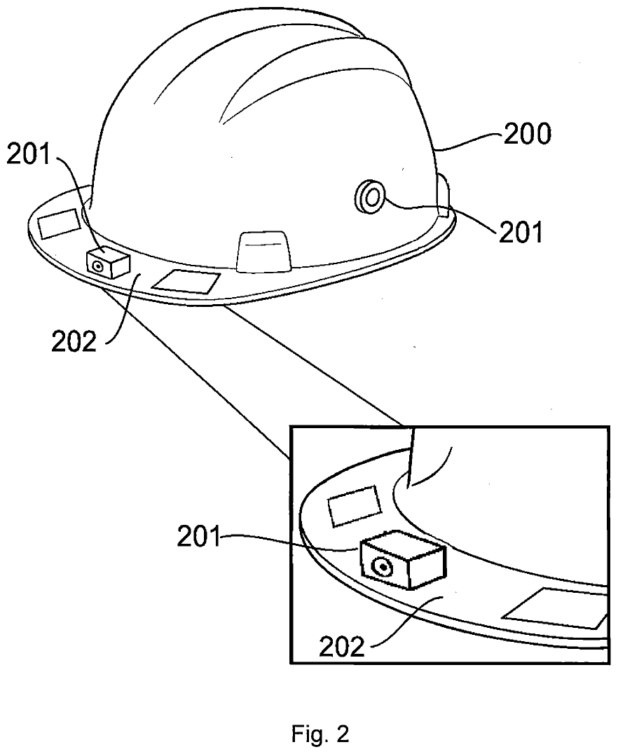

As illustrated in FIG. 2, the second wearable device (200), hereinafter referred to as the helmet module, comprises one or more strategically positioned wide-angle miniature cameras (201) configured to capture images of hand signals made by the signalman. In a preferred embodiment, the helmet module includes at least two cameras, although three or four cameras may be used to provide enhanced visual coverage. The helmet module further comprises a helmet module processing unit (202) configured to generate image data from the captured images. The helmet module processing unit (202) is operatively connected to the handheld device (300) via a wired connection to enable high-speed transmission of the image data for further processing.

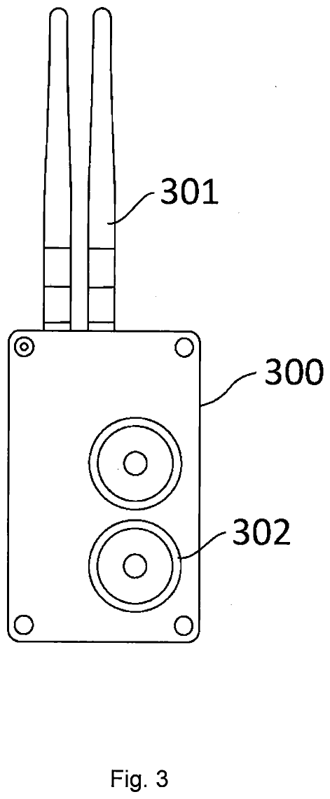

As illustrated in FIG. 3, the handheld device (300), hereinafter referred to as the receiver module, is configured to receive sensed hand signal data wirelessly from the glove modules (100) and image data from the helmet module (200) via a wired connection. The receiver module comprises a receiver module processing unit configured to compare the sensed hand signal data with the visual gesture data from the captured images and to generate a single decisive hand signal based on the comparison.

The receiver module processing unit further comprises a battery regulator and a radio transceiver with integrated antennas (301) to provide an extended range for radio signal transmission and reception. The receiver module also includes a battery storage unit with an integrated power regulator. Additionally, the handheld device (300) includes a rugged and strategically positioned audio output unit or speaker (302) configured to audibly announce the recognized hand signal upon receiving a confirmation signal from the display module (400), in a selected preferred language.

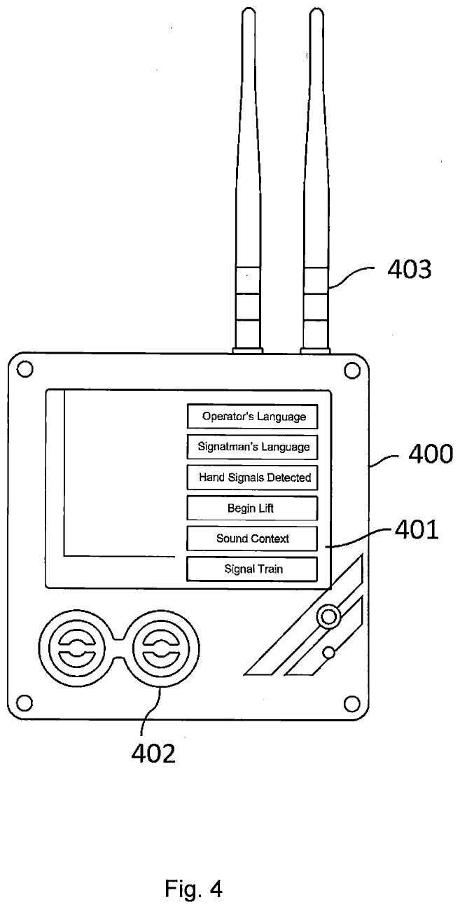

As illustrated in FIG. 4, the visual interface (400), hereinafter referred to as the display module, comprises a display monitor (401) configured to represent recognized hand signals visually, a radio transceiver with integrated radio antennas (403) configured to establish wireless communication with the receiver module (300), and a strategically positioned audio output unit or speaker (402) configured to announce the recognized hand signal audibly. The display module (400) further includes a display module processing unit configured to control and coordinate the operations of the display monitor (401), the audio output unit (402), and the radio transceiver (403). This processing unit is also responsible for interpreting the received single decisive hand signals, managing the timing of visual and auditory outputs, and handling database interactions.

The display module (400) is powered using an external power source. This external power supply ensures continuous operation of the visual and auditory output components, including the display monitor (401), audio output unit (402), and radio transceiver with antennas (403), without relying on internal battery power. The use of an external power source is particularly suited for fixed installations, such as within the cabin of construction equipment, where reliable and uninterrupted power is available. The radio transceiver (403) is further configured to receive the single decisive hand signals from the receiver module (300) and transmit a confirmation signal back to the receiver module (300), thereby enabling bidirectional communication and ensuring real-time data exchange. The display module (400) also includes a local database configured to store the single decisive hand signals.

In an optional embodiment, the database is further configured to store the visualized hand signals and the sensed hand signals received from the helmet and glove modules, respectively. In one embodiment, variations of all three types of hand signal data may include changes in frequency, hand movement patterns, the direction of hand movements, spacing between fingers, and the degree of bending of the thumb, index finger, and middle finger. The stored data may be used to train or refine machine learning models, allowing the system to improve recognition accuracy over time.

Additionally, the display module (400) incorporates an audible source designed to audibly announce the single decisive hand signal following the radio signals received from the receiver module (300). The display module (400) is preferably additionally furnished with criteria for selecting the preferred language for visual display and audible announcements. The display module (400) is preferably positioned for easy viewing by the construction equipment operator.

### Configuration & Operation of the Communication System

As illustrated in FIG. 5, a signalman is equipped with the glove modules (100), the helmet module (200), and the receiver module (300) to facilitate the communication of hand signals to an operator, even in scenarios where visual contact is not possible. Each glove module (100) includes a glove processing unit (102) programmed with an algorithm configured to interpret sensor data into sensed hand signals. Once processed, the glove module (100) transmits the sensed hand signals to the receiver module (300) via wireless Bluetooth communication.

The helmet module (200), via its helmet processing unit (202), is configured to process the images of hand signals captured by one or more cameras (201) positioned on the helmet. The helmet processing unit (202) transmits the captured image data to the receiver module (300) via a wired connection. The receiver module (300) utilizes advanced computer vision algorithms to analyze the incoming image data and to recognize and classify the hand signals visually performed by the signalman. The recognized visual hand signals are then compared with the sensed hand signals, which are transmitted via Bluetooth communication by the glove module (100). The receiver processing unit is configured to compare the visual and sensed hand signal data and, based on this comparison, generate a single decisive hand signal. This single decisive hand signal is then transmitted from the receiver module (300) to the display module (400) via the integrated radio transceiver and antennas (301).

In an embodiment, if a discrepancy is detected between the hand gesture data received from the glove module (100) and the image data received from the helmet module (200), the receiver module (300) initiates an error-handling procedure. As part of this procedure, the receiver module (300) audibly announces that the hand signal is unclear, prompting the signalman to re-perform the gesture. This feedback loop ensures that only validated and matched signals are communicated to the operator, thereby enhancing reliability and reducing the risk of miscommunication.

The display module (400) receives the radio signal containing the single decisive hand signal within the construction equipment operator's cabin. The signal is then presented to the operator visually, via the display monitor (401), and optionally audibly, via the speaker or audio output unit (402). This multifaceted communication approach ensures that the operator reliably receives the hand signal information, even under adverse conditions such as poor visibility, low light, or high construction noise. The display module (400) then transmits a confirmation signal back to the receiver module (300), indicating successful reception and acknowledgement of the hand signal.

In an optional embodiment, the operator can send, from the display module (400) to the receiver module (300), either a confirmation of receipt of the single decisive hand signal, an indication of non-receipt of the single decisive hand signal, or an indication of questions or concerns regarding single decisive hand signal. When the communication is a confirmation of receipt of the hand signal, it indicates a successful transmission. Upon receiving the confirmation signal from the display module (400), the receiver module (300) audibly announces the confirmation by replaying the corresponding hand signal audio through the audio output unit or speaker (302).

In an embodiment of the present disclosure, the single decisive hand signals may be stored in a database located either within the display module (400) or on an external storage system. The database is configured to continuously update with one or more variations of the single decisive hand signals.

### Method for Facilitating Hand Signal Recognition

The glove module (100) initiates the process by sensing and interpreting hand signals performed by the wearer or signalman. The interpreted hand signal data is transmitted to the receiver module (300) via a Bluetooth wireless communication network. Concurrently, as the signalman performs the hand signals, the helmet module (200) captures corresponding images and transmits them to the receiver module (300) through a wired connection to ensure fast and secure data transfer. Upon receiving both the interpreted hand signal data from the glove module (100) and the image data from the helmet module (200), the processing unit within the receiver module (300) analyzes and correlates the data to determine a single definitive hand signal. Once confirmed, the receiver module (300) transmits the finalized hand signal data to the display unit (400) over the wireless network. The display unit (400) promptly renders the signal on the display interface (401) as a visual representation of the hand signal. Simultaneously, an auditory announcement is generated to deliver both visual and audio cues to the construction equipment operator in a language comprehensible to the operator, ensuring clear and reliable communication. In addition, the display unit (400) transmits a receipt confirmation signal via a radio transceiver with antennas (403) back to the receiver module (300), verifying successful signal delivery. This confirmation is audibly acknowledged through the receiver module's audio output or speaker (301), thereby completing the communication loop.

In an embodiment of the present disclosure, the single decisive hand signals, and optionally also sensed hand signals and visualized hand signals are stored in a database within the display module (400). This database is continuously updated with one or more variations of the single decisive hand signals and can optionally also incorporate machine learning algorithms to decipher variations in hand signals

The sensor data from the glove module (100) is processed into corresponding hand signals by a glove processing unit (102). Once a hand signal is interpreted, the glove module (100) transmits the processed hand signal to the receiver module (300). This sensing and transmission process is performed continuously at a prescribed time interval to enable real-time hand gesture recognition. The glove processing unit (102) constantly, at some specified time interval, receives sensor input from the sensors (101), processes the data and transmits the resulting hand signal information to the receiver module (300), ensuring timely and consistent communication of gesture data. The data transfer is performed at regular intervals to ensure continuous data transmission and to establish and maintain reliable connectivity between the glove module (100) and the receiver module (300).

In another embodiment of the present disclosure, the helmet module captures images at a prescribed frame rate. The captured images from two or more cameras (201) are combined into a single data packet by the helmet processing unit (202) and transmitted to the receiver module (300) via a wired connection to ensure secure and fast data transfer.

In another embodiment of the present disclosure, the receiver module (300) receives the sensed hand signal data from the glove module (100) and the captured image data from the helmet module (200) at a prescribed time interval. Based on the received data, the receiver module (300) generates a decisive hand signal, which is then transmitted to the display module (400) via a radio transceiver and antennas (301) at prescribed time intervals. The receiver module (300) continuously transmits the same decisive hand signal until a change is detected, as initiated by updated input from the glove module (100) and the helmet module (200).

In another embodiment of the present disclosure, once the single decisive hand signal is transmitted to the display module (400) through the wireless communication network, the display module (400) determines whether the received hand signal is a continuation of the previously displayed single decisive hand signal. If it is determined to be a continuation, the display module (400) displays the previously shown hand signal graphically. The display is only updated when the display module (400) receives a different decisive hand signal from the receiver module (300), prompting it to render the updated hand signal accordingly.

In another embodiment of the present disclosure, the display module (400) continuously transmits a receipt signal—indicating the currently displayed hand signal on the display monitor (401)—to the receiver module (300) wirelessly, using a radio transceiver with antennas (403), at a prescribed time interval. Upon receiving the receipt signal, the receiver module (300) audibly announces the confirmed hand signal once through an audio output unit or speaker (302). The receiver module (300) announces each hand signal only once upon receiving a new or updated receipt signal from the display module (400).

In another embodiment of the present disclosure, the receiver module (300) and the display module (400) continuously exchange radio signals at prescribed time intervals to maintain synchronization and verify communication integrity. If either module detects a loss of connection or fails to receive the expected radio signal within a predefined timeout period, both the receiver module (300) and the display module (400) audibly announce the disconnection of the communication loop through their respective audio output units. This configuration establishes a duplex communication protocol with continuous loop integrity monitoring, thereby enhancing the system's reliability and its ability to detect faults in real-time. This duplex mechanism ensures that communication errors, signal dropouts, or hardware malfunctions are promptly detected and conveyed to the relevant personnel.

In an exemplary embodiment, a signalman is equipped with a pair of glove modules (100), a helmet module (200), and a receiver module (300) at a construction site. The signalman is positioned to communicate hand signals to an operator seated inside the cabin of construction equipment, where the display module (400) is installed within close view of the operator to serve as the user interface. Assuming the signalman performs a “Raise Boom” hand signal-commonly recognized in mobile crane operations—the signal involves three distinct hand movements: (i) extending one arm horizontally to the side of the body, (ii) forming a closed fist, and (iii) signalling a thumbs-up gesture. These movements may be performed in varying sequences, as the system is designed to recognize the signal regardless of the order in which the gestures are executed.

The glove module (100) detects the “Raise Boom” hand signal through one or more sensors (101) embedded within the glove module (100), by tracking each of the constituent hand movements. First, the extension of the arm horizontally to the side of the body is sensed by measuring the orientation of the palm using a 3-axis accelerometer and a 3-axis gyroscope located within the glove module processing unit (102). Second, the closing of the first is detected, followed by the third movement-signaling a thumbs-up gesture. In the event of sensor malfunction or failure in gesture interpretation, the glove module (100) continues to re-sense the hand movements at a prescribed time interval until the complete hand signal can be accurately recognized. Once all three movements have been successfully sensed and interpreted, the glove module (100) transmits the recognized “Raise Boom” hand signal to the receiver module (300) via a Bluetooth wireless communication link for further processing. The data transfer is performed at regular intervals to ensure continuous data transmission and to establish and maintain reliable connectivity between the glove module (100) and the receiver module (300).

Simultaneously, as the signalman performs the “Raise Boom” hand signal, one or more cameras (201) within the helmet module (200) capture images of the three distinct movements. The helmet module processing unit (202) compiles these captured images into a single data packet and transmits them to the receiver module (300) through a secure wired connection at specified regular time intervals. The receiver module (300) receives the image data and compares it with the sensed hand signal data received from the glove module (100). The receiver module determines whether the newly captured images are a continuation of the previously received image sequence and whether they correspond to a stable hand gesture with no ongoing changes. If it is determined that the image sequence represents a consistent gesture and corresponds with a recognized pattern, a visualized hand signal is created. This visualized hand signal is then compared with the sensed hand signal to generate a single decisive hand signal. If both inputs match, the system confirms the recognized gesture as the known “Raise Boom” hand signal. The confirmed single decisive hand signal is transmitted to the display module (400). Upon receiving the signal, the display module (400) verifies that the transmitted hand signal corresponds to the “Raise Boom” gesture, and subsequently, both display it visually and announce it audibly within the construction equipment cabin. The display module (400) also sends a receipt confirmation signal back to the receiver module (300). Upon receiving this receipt signal, the receiver module (300) audibly announces “Raise Boom” via its speaker (302), thereby providing two confirmations to the signalman: first, that the display module (400) has successfully received the single decisive hand signal, and second, that the transmitted and confirmed signal was indeed the “Raise Boom” command.

The transmission of hand signals and feedback across all communication paths-including from the glove module (100) to the receiver module (300), from the helmet module (200) to the receiver module (300), from the receiver module (300) to the display module (400), and from the display module (400) back to the receiver module (300)—via the wireless and wired communication network continues throughout the entire duration of construction equipment operation. This continuous bidirectional communication enhances safety, ensures consistent signal delivery, and supports operational efficiency in dynamic construction environments.

Thus, the present disclosure effectively addresses the limitations of traditional communication systems used in construction equipment operations, particularly in situations where direct visual contact between the signalman and the equipment operator is impaired or restricted. By integrating advanced sensor technologies and computer vision algorithms, the system reliably detects and interprets hand signals conveyed by the signalman. These recognized signals are communicated to the operator through synchronized visual and auditory outputs, ensuring timely, clear, and accurate interpretation-thereby improving operational efficiency and enhancing overall safety on the worksite.

Although the present disclosure has been described and illustrated with reference to preferred embodiments and applications, it will be understood by those skilled in the art that various modifications, adaptations, and equivalent arrangements may be made without departing from the scope of the invention. The scope of the present disclosure is intended to be defined by the appended claims and all equivalents thereto.

What is claimed is:

1. A system for facilitating hand signal recognition and communication in construction equipment operations, comprising:
a. a glove module comprising
i. one or more sensors configured to detect hand gestures of a signalman;
ii. motion-tracking devices to track hand orientation and motion.
b. a helmet module comprising
i. at least two wide-angle cameras positioned to capture overlapping fields of view of the signalman's hand gestures; and;
ii. a wired data link for low-latency image transmission.
c. a receiver module configured to
i. wirelessly receive gesture data from the glove module via Bluetooth at specified intervals,
ii. receive synchronized image data from the helmet module via the wired connection, and
iii. validate congruence between the gesture and image data to generate a decisive hand signal.
d. a display module located within an equipment cabin, configured to:
i. receive the single decisive hand signal from the receiver module via a wireless communication network,
ii. visually and audibly communicate the decisive hand signal to an equipment operator and
iii. transmit a receipt confirmation signal back to the receiver module.

2. The system of claim 1, wherein the glove module comprises a 3-axis accelerometer and a 3-axis gyroscope to detect the orientation and motion of the hand.

3. The system of claim 1, wherein the helmet module comprises at least two wide-angle miniature cameras to capture hand signal images and a processing unit configured to transmit the captured images as packed data to the receiver module.

4. The system of claim 1, wherein the receiver module includes a processing unit configured to receive gesture data wirelessly and image data via a wired connection, an audio output unit, and a radio transceiver.

5. The system of claim 1, wherein the display module includes a processing unit configured to control the display monitor, audio output unit, and radio transceiver.

6. The system of claim 1, wherein for uninterrupted operation, separate battery storage units power the glove and receiver modules, and an external power source powers the display module.

7. The system of claim 1, wherein the receiver and display modules are configured to exchange radio signals to continuously verify and maintain communication integrity.

8. The system of claim 1, wherein the display module includes a local database configured to store recognized hand signals and their variations.

9. A method for recognizing and communicating hand signals in a construction environment comprising:
a. detecting hand gestures using a glove module comprising bending sensors, motion and position sensors;
b. capturing image data of the hand gestures using a helmet module comprising two or more wide-angle miniature cameras;
c. wirelessly transmitting the processed gesture data from the glove module to a receiver module using a Bluetooth communication link;
d. transmitting the captured image data from the helmet module to the receiver module as packed data through a wired communication link;
e. comparing the gesture data and image data in the receiver module, using its processing unit, to determine a validated hand signal based on their congruence;
f. transmitting the single decisive hand signal to a display module;
g. displaying the hand signal on a visual interface and announcing it via an audio output unit in a language understood by an operator; and
h. transmitting a confirmation signal from the display module back to the receiver module to complete the communication loop.

10. The method of claim 9 further comprises repeating the transmission of the single decisive hand signal until a different hand signal is recognized.

11. The method of claim 9 further comprises storing the recognized hand signals in a local database for future reference or machine learning training.

12. The method of claim 9 further comprises announcing the confirmation signal via a speaker in the receiver module in a language understood by a signalman.

13. The method of claim 9, wherein the system enters an alert state if communication between the receiver and display module is lost.

14. The method of claim 9, wherein gesture detection and image capture are performed at a prescribed time interval to enable continuous and synchronized data acquisition.

15. A non-transitory computer-readable medium storing instructions that, when executed by one or more processors, cause a system to perform a method for duplex communication in a hand signal recognition system, cause a system to perform operations comprising:
a. receiving, at a display module, a single decisive hand signal from a receiver module over a wireless communication network;
b. displaying the hand signal on a display monitor and announcing it via an audio output unit in the language understood by an operator;
c. transmitting, from the display module to the receiver module, a receipt confirmation signal indicating successful reception of the hand signal;
d. receiving, at the receiver module, the confirmation signal from the display module;
e. announcing, at the receiver module, the confirmed hand signal via an audio output unit in a language understood by a signalman;
f. periodically exchanging radio signals between the display module and the receiver module to verify the integrity of the communication loop; and
g. initiating an audible and/or visual disconnection alert at both modules upon detection of communication failure or timeout.

16. The method of claim 15, wherein the confirmation signal includes a reference to the specific hand signal identifier for synchronization verification.

17. The method of claim 15, wherein the periodic radio signals are exchanged at prescribed time intervals, and a timeout is triggered if a signal is not received within a predefined duration.

18. The method of claim 15, wherein the system announces the disconnection upon disconnection and logs the time and signal state to a local database for fault analysis.

19. The method of claim 15 further comprises audibly announcing an unclear hand signal when a discrepancy is detected between glove and helmet data, prompting the signalman to repeat the gesture.
